(19) United States
(12) Patent Application Publication
(10) Pub. No.: US 2020/0031307 A1
(43) Pub. Date: Jan. 30, 2020

(54) LAMINATE FILM FOR PROTECTION DEVICE

(71) Applicant: TRW Vehicle Safety Systems Inc., Washington, MI (US)

(72) Inventor: Bruce R. Hill, Bloomfield Hills, MI (US)

(21) Appl. No.: 16/047,047

(22) Filed: Jul. 27, 2018

(51) Int. Cl. B60R 21/235; B60R 21/232; B32B 7/12; B32B 5/02; B32B 27/12; B32B 27/36; B32B 37/12

(52) U.S. Cl. CPC B60R 21/235; B60R 21/232; B32B 7/12; B32B 5/024; B32B 27/12; B60R 2021/003; B32B 37/12; B60R 2021/23509; B60R 2021/23519; B60R 2021/23542; B60R 2021/2358; B32B 27/36

(57) ABSTRACT

A laminate film for a vehicle occupant protection device has at least one copolyester barrier layer and at least one copolyester adhesive layer connected to the at least one barrier layer.

### TECHNICAL FIELD

The present invention relates generally to an apparatus for helping to protect an occupant of a vehicle. More particularly, the present invention relates to a laminate film for a one-piece woven (OPW), inflatable air bag.

### BACKGROUND OF THE INVENTION

It is known to inflate an inflatable vehicle occupant protection device to help protect a vehicle occupant in the event of a vehicle collision. Examples of inflatable vehicle occupant protection devices include driver and passenger frontal air bags, side air bags, curtain air bags, inflatable seat belts, inflatable knee bolsters, and inflatable head liners.

Inflatable vehicle occupant protection devices can have a variety of constructions. For example, an inflatable vehicle occupant protection device can be constructed of overlying woven panels that are interconnected by means, such as stitching or ultrasonic welding, to form connections or seams that help define an inflatable volume of the protection device. As another example, an inflatable vehicle occupant protection device can have an OPW construction in which overlying panels are woven simultaneously. The panels are woven together to form connections or seams that help define an inflatable volume of the OPW protection device.

In some instances, the OPW protection device is laminated with a polyolyfin-based adhesive layer and a polyether blockamide surface layer. During the module validation phase, the polyolyfin adhesive layer can de-laminate from the woven textile during deployment after the module has been subjected to excess moisture. This can occur during the salt spray portion of the validation.

Another issue with current laminate films is the top layer can separate from the adhesive layer—also known as cohesive failure mode. This is normally observed post-deployment at elevated temperatures and is due to the softening of the adhesive layer.

### SUMMARY OF THE INVENTION

In one example, a laminate film for a vehicle occupant protection device has at least one copolyester barrier layer and at least one copolyester adhesive layer connected to the at least one barrier layer.

In another example, a method of forming an apparatus for helping to protect an occupant of a vehicle includes weaving an inflatable vehicle occupant protection device comprising a plurality of panels defining an inflatable volume. The panels are laminated with a film having at least one copolyester barrier layer and at least one copolyester adhesive layer connected to the at least one barrier layer.

### BRIEF DESCRIPTION OF THE DRAWINGS

FIG. 1 is a schematic view of an apparatus for helping to protect an occupant of a vehicle according to the present invention.

FIG. 2 is a side view of a curtain air bag of the apparatus of FIG. 1.

FIG. 3A is a sectional view generally along line 3A-3A of FIG. 2 illustrating the weave of a portion of the curtain air bag.

FIG. 3B is a sectional view generally along line 3B-3B of FIG. 2 illustrating a laminate film on the curtain air bag in accordance with the present invention.

FIG. 3C is a sectional view generally along line 3C-3C of FIG. 2 illustrating a laminate film on the curtain air bag in accordance with the present invention.

FIG. 4 is a side view of a roll of fabric material for forming the curtain air bag of FIG. 2.

FIG. 5 illustrates the roll of FIG. 4 in an unfurled state.

FIG. 6 is a flow chart illustrating a method of forming the curtain air bag of FIG. 2.

FIG. 7 is a section view of a curtain air bag in accordance with another example and including a flame-retardant material.

FIG. 8 is a graph illustrating coefficient of friction plots for different laminate film extrusion processes.

### DETAILED DESCRIPTION

The present invention relates generally to an apparatus for helping to protect an occupant of a vehicle. More particularly, the present invention relates to a laminate film for an OPW, inflatable air bag.

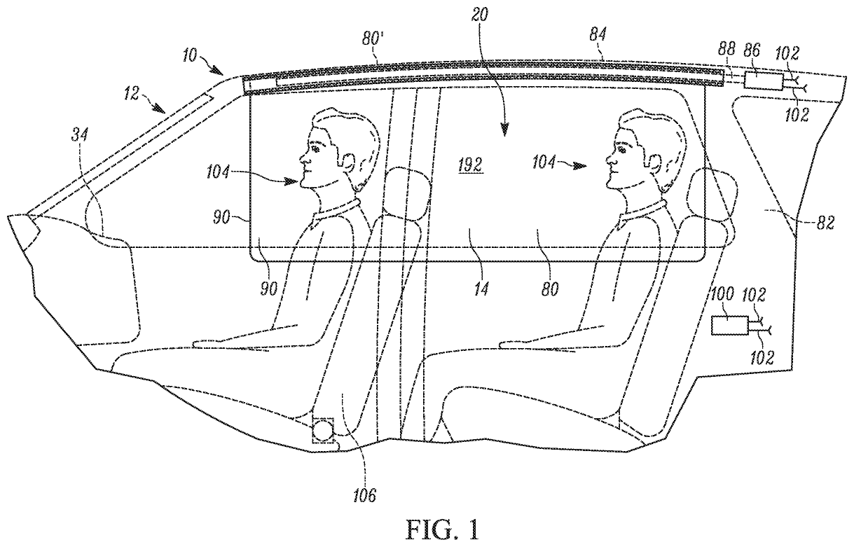

FIG. 1 illustrates a vehicle 12 that can include one or more apparatuses 10 in the form inflatable vehicle occupant protection devices 14 that are inflatable to help protect one or more occupants 104 of the vehicle 12. One example apparatus 10 constitutes a curtain air bag or inflatable curtain for deployment between a side structure 82 of the vehicle 12 and the vehicle occupant(s) 140. In this configuration, the curtain air bag can cover at least two of the A, B, and C pillars of a vehicle 12. It will be understood, however, that the apparatus 10 of the present invention can also be configured for placement and deployment in any known location of the vehicle, e.g., steering wheel, door, front seat, etc. The apparatus 10 can therefore be used to protect the driver and/or any number of passengers in the vehicle.

The curtain air bag 80 is positioned on a passenger side 20 of the vehicle 12. A similar or identical protection device (not shown) can be positioned on a driver side of the vehicle. Other vehicle occupant protection devices (not shown) that can be constructed in accordance with the invention can include, for example, side impact air bags, inflatable seat belts, inflatable knee bolsters, and inflatable head liners positioned accordingly in the vehicle 12.

The curtain air bag 80 is mounted adjacent the side structure 82 and roof 84 of the vehicle, An inflator 86 is connected in fluid communication with the curtain air bag 80 through a fill tube 88. The inflator 86 can have a known construction suitable for inflating the curtain air bag 80. For example, the inflator 86 can contain a stored quantity of pressurized inflation fluid (not shown) in the form of a gas for inflating the curtain air bag 80. Alternatively, the inflator 86 can contain a combination of pressurized inflation fluid and ignitable material for heating the inflation fluid, or can be a pyrotechnic inflator that uses the combustion of gas-generating material to generate inflation fluid. As a further alternative, the inflator 86 can be of any suitable type or construction for supplying a medium for inflating the curtain air bag 80.

The fill tube 88 includes openings (not shown) through which inflation fluid is directed into the curtain air bag 80. The fill tube 88 can be constructed of any suitable material, such as plastic, metal or fabric. The fill tube 88 can alternatively be omitted, in which case the inflator 86 can be connected directly to the curtain air bag 80. The curtain air bag 80 is inflatable from a deflated and stored condition, illustrated in dashed lines at 80′ in FIG. 1, to an inflated and deployed condition, illustrated in solid lines at 80 in FIG. 1.

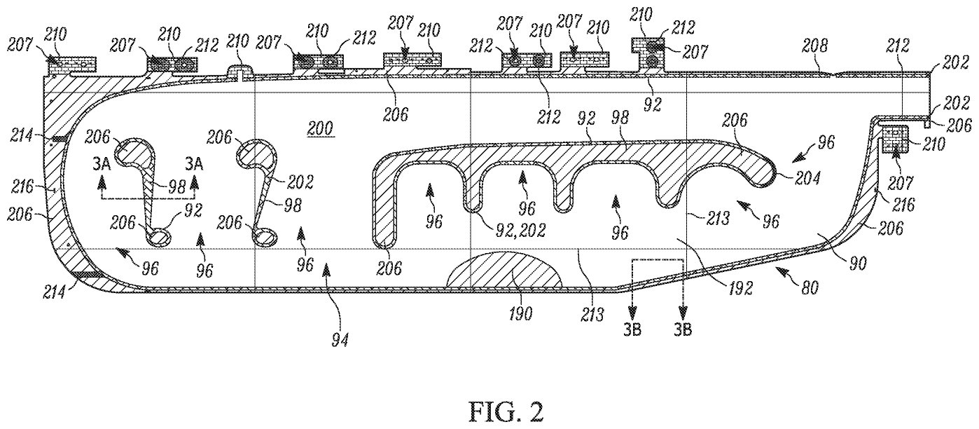

Referring to FIG. 2, in this example configuration, the curtain air bag 80 includes integrally formed panels 90 that define an inflatable volume 94. Seams 92 extending along the panels 90 help define inflatable chambers 96 within the inflatable volume 94 and non-inflatable portions 98 of the curtain air bag 80. The curtain air bag 80 has an OPW construction in which the air bag is a single unitary woven article with portions, i.e., the panels 90, woven simultaneously as separate, single layers of material, and portions, i.e., the seams 92, woven as a single layer. The OPW construction can be especially beneficial in a curtain air bag construction because this construction can afford long duration inflation and high pressurization capabilities, which can be desirable for this and other types of air bags. The panels 90 and seams 92 together define the inflatable volume 94 and inflatable chambers 96.

The particular OPW configuration of the curtain air bag 80 is by way of example only. The present invention is suited for implementation in OPW air bag structures having any configuration, e.g., multiple inflatable portions, a single inflatable portion, no inflatable portions, and any number of seams, including zero.

The vehicle 12 includes one or more sensors (shown schematically at 100 in FIG. 1) for sensing the occurrence of an event for which inflation of the curtain air bag 80 is desired. Examples of such events include a vehicle impact, e.g., front, rear, side, offset, or angled impacts, a vehicle rollover, or both. Upon sensing the event, the sensor 100 provides electrical signal(s) over lead wires 102 to the inflator 86, which causes the inflator to be actuated in a known manner and discharge fluid under pressure into the inflatable volume 94 of the curtain air bag 80.

The example configuration of the curtain air bag 80 inflates under the pressure of the inflation fluid from the inflator 86 away from the roof 84 to a position between the side structure 82 of the vehicle 12 and any occupants 104 of the vehicle. The curtain air bag 80, when inflated, helps protect the vehicle occupant(s) 104 in the event of an impact to the vehicle 12, a vehicle rollover, or both. The curtain air bag 80, when inflated, also helps absorb the energy of impacts with the curtain air bag and helps distribute the impact energy over a large area of the curtain air bag.

The curtain air bag 80 has a construction that promotes seam integrity, easier and more compact packaging, and uniform shrinkage in the weft direction. To accomplish this, in the OPW construction of the curtain air bag 80, the panels 90 are woven with various different weave patterns. The curtain air bag 80 has a length measured in a warp direction (left to right as viewed in FIG. 2) of the curtain air bag. A width is measured perpendicular to the length and in a weft direction (top to bottom as viewed in FIG. 2) of the curtain air bag 80. In one example, the curtain air bag 80 is woven from polyester yarns.

Portions 200 of the curtain air bag 80 (indicated without cross-hatching) identify portions of the woven panels 90 woven in separate layers with the double layer plain weave. Portions 202 (cross-hatched) of the curtain air bag 80 identify portions of the woven panels 90 woven together with the 1×2 low float weave pattern to help form the seams 92 of the curtain air bag 80. Portions 204 (cross-hatched) of the curtain air bag 80 identify portions of the woven panels 90 woven together with a gegenschlauch (“counter tube”) seam to help form additional seams 92 of the curtain air bag 80. The portions 202, 204 forming the seams 92 can have an alternative weave pattern, such as a 3×3 panama or basket weave pattern, alternative basket weave pattern or weave repeat pattern.

A portion 206 (cross-hatched) extends around the entire periphery 208 of the curtain air bag 80 and identifies portions of the panels 90 woven together with a BST 99 weave pattern. Portions 210 (cross-hatched) of the curtain air bag 80 are provided along the top of the periphery 208 and at the rear end of the curtain air bag. Each portion 210 includes one or more openings 207 that receive fasteners (not shown) to help secure the curtain air bag 80 to the vehicle 12 adjacent the roof 84. The portions 210 identify portions of the panel 90 woven together with a rip stop weave pattern. Portions 212 (cross-hatched) of the curtain air bag 80 are provided within the perimeter of some portions 210 and identify portions of the panel 90 woven together with a BST 24 weave pattern. The portions 212 extend around the openings 207 in the portions 210.

Portions 214 (cross-hatched) of the curtain air bag 80 are provided at the front end of the curtain air bag and identify portions of the panels 90 woven together with a 3×3 panama/basket weave pattern. Portions 216 of the curtain air bag 80 are provided at the front and rear ends of the curtain air bag and identify portions of the panels 90 woven together with a measure marker weave pattern. It will be understood that any of the non-plain weave portions 206, 210, 212, 214, 216 can exhibit alternative non-plain weave patterns or a plain weave pattern known in the art.

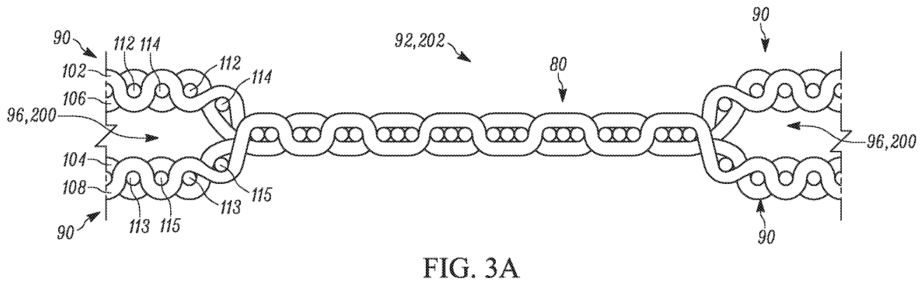

Referring to FIG. 3A, the panels 90 each includes warp yarns, or “ends”, indicated at 102, 104, 106, 108. The panels 90 also each includes weft yarns, or “picks,” indicated at 112, 113, 114, 115. The warp yarns 102-108 and weft yarns 112-115 are oriented perpendicular to each other. The warp yarns 102-108 are interlaced with the weft yarns 112-115 in an alternating or “up and down” manner. A weave diagram 119 illustrating how the panels 90 are woven together is shown in FIG. 3B.

Weave patterns include what are referred to in the art as “floats.” A “float” refers to the number of adjacent warp yarns 102-110 or a weft yarns 112-115 that a weft yarn or warp yarn, respectively, extends over or under. The number of floats in a woven fabric varies with the particular type of weave with which the fabric is woven. For example, a plain woven fabric includes single floats because the warp and weft yarns pass over and under single weft and warp yarns, respectively. As another example, a 2×2 woven fabric includes two floats because the warp yarns and weft yarns pass over and under two adjacent weft and warp yarns, respectively.

In areas of a fabric where different weave patterns interface with each other floats in addition to those normally occurring in the weave patterns may occur. This is especially relevant in an OPW air bag design where a double layer plain weave interfaces with a non-plain weave pattern, e.g., at the transitions between the inflatable chambers 96 and the seam 92. The number and location of these excess floats is determined by the weave pattern of the fabric at the interface. While the existence of excess floats at the interface may be unavoidable, the weave pattern may be configured, to a large extent, to help place a desired number of floats in a desired location at the interface between the weave patterns.

That said, the seams 92 have constructions that vary in order to provide a desired function for the particular seam. In the portion illustrated in FIG. 3A, the seam 92 is a single layer defined by two adjacent, interconnected portions 93, 95. The portion 93 has a non-plain, two-by-two (2×2) Panana weave pattern (also known as a Panama weave). The portion 95 has a non-plain, three-by-three (3×3) Panama weave pattern (also known as a low float weave pattern). Low float weave patterns are shown and described in more detail in U.S. Patent Publication No. 2006/0284403, the entirety of which is incorporated herein by reference.

In FIG. 3B, the shaded blocks indicated at 130 in the weave diagram 119 indicate the warp yarn being “up” or passing over the corresponding fill yarn as viewed looking down on the panels 90 as shown in FIG. 2. The non-shaded blocks indicated at 132 in the weave diagram 119 indicate the warp yarn being “down” or passing under the corresponding fill yarn as viewed looking down on the panels 90 as viewed in FIG. 2.

The plain woven and non-plain woven portions of the panels 90 can have different permeabilities. For example, the non-plain woven portions can have a higher permeability than the plain woven portions due to the looser weave and higher propensity for yarn shifting in the non-plain weave. A coating 190 (see FIG. 2) can be applied to the panels 90 to help control the gas permeability of the panels and maintain the gas permeability of the panels at a desired level. The coating 190 can also be omitted (not shown). The curtain air bag 80 can thus maintain the improved seam integrity and packaging provided by the plain and non-plain woven portions described above without sacrificing permeability.

Referring to FIG. 3C, a laminate film 192 is applied to the curtain air bag 80 to provide desired performance characteristics. The curtain air bag 80 can be in loom state—not scoured or sized—when the laminate film 192 is applied thereto. The laminate film 192 can be a gas impermeable or substantially gas impermeable material. The laminate film 192 includes at least one first, barrier layer 194 and at least one second, adhesive layer 196 for securing the barrier layer(s) to the curtain air bag 80. The barrier layer 194 and adhesive layer 196 can be coextruded. The barrier layer 194 can includes one or more polymer materials, such as a copolyester or, more specifically, a thermoplastic polyester elastomer (TPC-ET). Example TPC-ET materials include Hytrel® (DuPont™) materials, such as Hytrel® 4069, Hytrel® 3078, Hytrel® G5544 or Arnitel® (DSM Engineering Plastics) materials, such as Arnitel® EM 550. The barrier layer 194 can have a melt temperature of about 170° C. to 225° C. In any case, the barrier layer 194 is selected to have a desired hardness, e.g., at least a Shore D hardness of 40, and a desired coefficient of friction, e.g., less than about 0.90. The dynamic coefficient of friction can be less than about 0.70. The static coefficient of friction can be less than about 0.85.

The adhesive layer 196 can include one or more polymer materials, such as a polyether-based thermoplastic polyurethane (TPU) or a copolyester, such as TPC-ET. Example TPU materials include Estane® (Lubrizol) materials, such as Estane® 58630 and Estane® 58300. Example TPC-ET materials for the adhesive layer 196 include Hytrel® materials, such as Hytrel® 4056. The adhesive layer 194 can have a melt temperature of about 120° C. to 160° C. The adhesive layer 196 is selected to have a lower melt temperature than the barrier layer 194.

Any number of barrier layers 194 and/or adhesive layers 196 can form the laminate film 192. The barrier layers 194 can be the same or different from one another. The adhesive layers 196 can be the same or different from one another. In any case, the laminate film 192 can have a weight of about 45-60 g/m³. The laminate film 192 is especially suited for adequately adhering to loom state fabrics.

The laminate film 192 is formed by co-extruding the adhesive layer(s) 196 and barrier layer(s) 194 together. In one example, the laminate film 192 is formed by a blown film extruder. The blown film extruder can be a 3- or 5-layer extruder with, for example, a 4″ diameter die with a maximum tubular width of about 17″. Blown film extrusion is advantageous in that the laminate film 192 produced can have both the desirable hardness and coefficient of friction. In other words, the blown film extruder is capable of extruding laminate films 192 that exhibit an increased hardness with a reduced coefficient of friction (or tackiness).

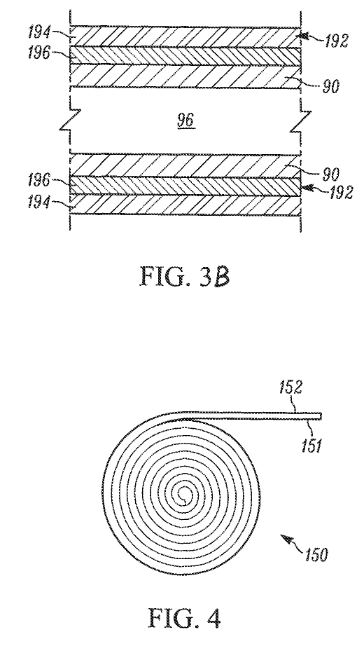

The panels 90 used to construct the curtain air bag 80 are formed in a continuous roll of fabric material 150, shown in FIG. 4. The weave patterns used to weave the panels 90 are selected to promote processing the woven roll 150 of material. Once the roll 150 is produced, the laminate film 192 is applied to the roll. The roll 150 can be in its loom state when the laminate film 192 is applied thereto.

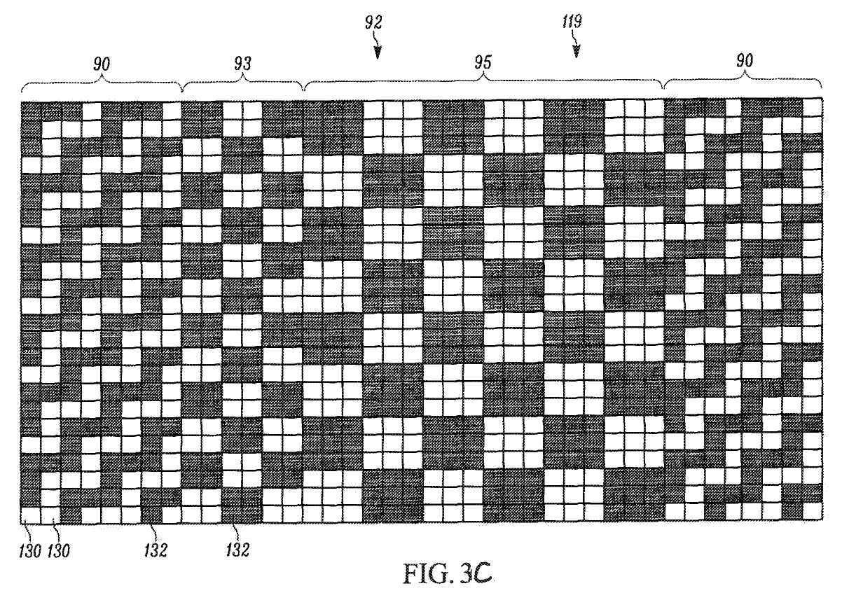

The panels 90 are then cut out from the roll to define the curtain air bag 80. This cutting can be performed by cutting machines (not shown) that use vision systems to help improve cutting accuracy. The vision systems search for markers on the fabric of the roll 150 that allow the system to determine whether cuts are being made at the proper locations. Typically, these markers comprise intersecting marker yarns 213 woven into the fabric of the panels 90, as shown in FIG. 5 with the roll 150 in an unfurled state. The marker yarns 213 have a color that is different from the rest of the fabric on the roll 150 and thus stand out visually. The marker yarns 213 are visible on a first side 152 of the roll 150, with a second, opposite side 151 of the roll being white.

To weave the intersecting marker yarns 213, a beam of warp yarn having the marker color is installed at one or more warp positions on the loom. To form the marker yarn intersections, yarns are inserted at the appropriate weft locations along the length of the roll 150 and inserted at the appropriate warp locations. As a result, a grid of warp and weft marker yarns yarns 213 is formed on the roll 250. The marker yarns 213 can be, for example, 470 dtex black marker yarns capable of being recognized by the vision system.

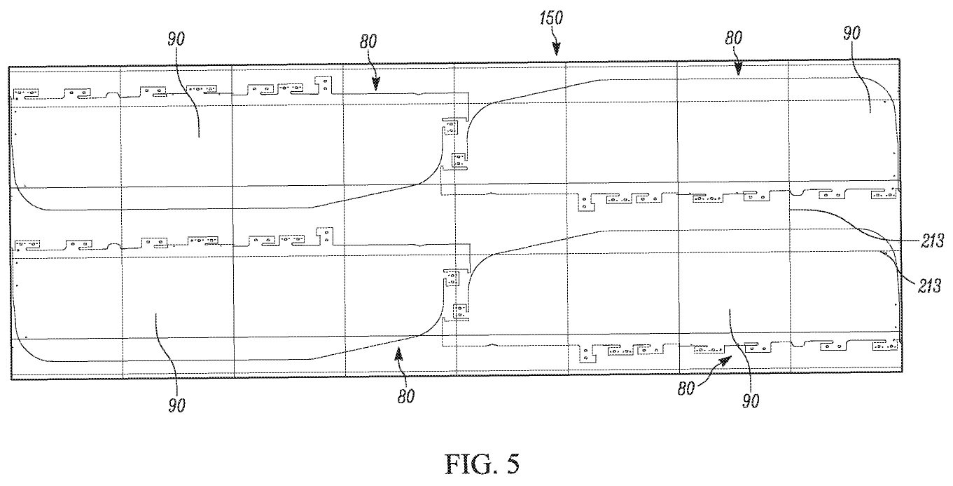

In one example method 300 shown in FIG. 6 for forming the curtain air bag 80, at step 310, the yarns are warped before being woven on a loom at step 320 to form the roll 150 shown in FIG. 4 having an OPW construction. The OPW curtain air bag 80 can be woven using Jacquard rapier weaving (about 400 picks/min) or Jacquard air-jet weaving (about 600 picks/min). The roll 150 can be in its loom state or sized/scoured at this point. At step 330, the woven roll 150 is laminated to the laminate film 192 in a single pass. At step 340, the laminated roll is cut to form the curtain air bag 80.

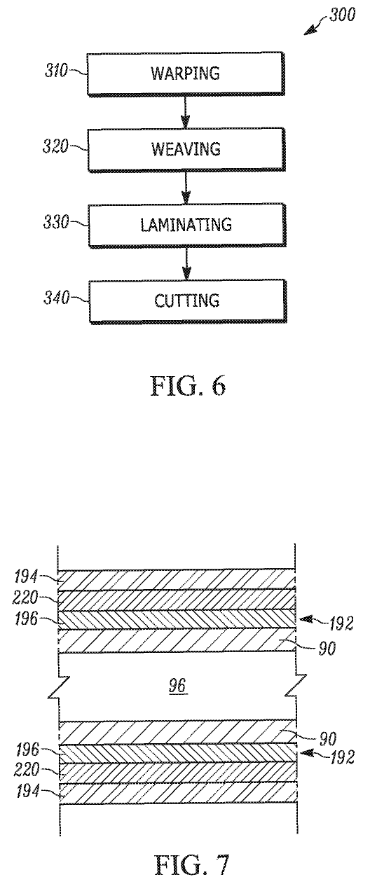

In another example shown in FIG. 7, the laminate film 192 also includes a flame-retardant material or layer 220. The flame-retardant material 220 can be a separate layer coextruded with the layers 194, 196 (as shown) or mixing with the barrier layer material and/or adhesive layer material and extruded therewith (not shown). In other words, the flame-retardant material 220 can be interspersed within one or both of the layers 194, 196.

The flame-retardant material 220 reduces the burn rate of the composite laminate film 192 on the curtain air bag 80. The flame-retardant material 220 can include one or more polymer materials, such as a copolyester or, more specifically, a TPC-ET. Example TPC-ET materials include Hytrel® materials, such as Hytrel® HTR8800 NC010 and Hytrel® 51FR. The flame-retardant material 220 can have a melt temperature of about 145° C. to 155° C.

The laminate film of the present invention is advantageous for providing increased peel strength and resistance to separation/de-lamination compared to current air bag laminations. To this end, using similar materials to form the layers of the laminate film, e.g., both copolyester materials, renders the laminate film less likely to separate or de-laminate due to the bonding between the layers. Moreover, using materials for the laminate film that are similar or identical to the yarn material in the curtain air bag increases the bond between the laminate film and the yarns, thereby increasing the resistance to separation between the laminate film and the curtain air bag. The laminate film of the present invention is also advantageous in that the adhesive layer has a higher melt temperature than conventional curtain air bag laminate films.

### Example 1

In this study, a number of coextruded laminate films were formed and tested. OPW inflatable air bags were formed with PET 470 dtex Halead yarn. The air bags were plain woven and hand laminated. The air bags were laminated with control laminations (see “Nolax” films) already known in the art and coextruded laminate films according to the present invention (see “17-03-” films). Each laminated air bag was placed in a heated chamber and inflated slowly with shop air. When the film de-laminated the pressure was recorded along with the failure mode.

TABLE 1

| | | | | | Max | | | |
|---|---|---|---|---|---|---|---|---|
| | | | | | lam | Residual | Burst | |
| | Barrier | Adhesive | | | temp | pressure | @ 85 C. | Failure |
| Film | layer | layer | ETR | Aging | (° C.) | (kPa)* | (kPa) | mode |
| 17-03-16-2 | Hytrel | Estane | 17-06-6790 | AR | 166 | 13 | 54 | Delamination - |
| | 4069 | 58630 | | | | | | cohesive |
| 17-03-16-2 | Hytrel | Estane | 17-06-6790 | AR | 171 | 11 | 54 | Delamination - |
| | 4069 | 58630 | | | | | | cohesive |
| 17-03-16-1 | Hytrel | Hytrel | 17-06-6790 | AR | 177 | 38 | 132 | Delamination - |
| | 4069 | 4056 | | | | | | adhesive |
| 17-03-16-1 | Hytrel | Hytrel | 17-06-6790 | AR | 177 | 33 | 94 | Delamination - |
| | 4069 | 4056 | | | | | | adhesive |
| 17-03-17-1 | Hytrel | Estane | 17-06-6790 | AR | 177 | 38 | 60 | Delamination - |
| | 4069 | 58300 | | | | | | adhesive |
| 17-03-17-1 | Hytrel | Estane | 17-06-6790 | AR | 171 | 34 | 66 | Delamination - |
| | 4069 | 58300 | | | | | | adhesive |
| Nolax | Vestimid | Polyolyfin | 17-06-6790 | AR | 160 | 37 | 64 | Delamination - |
| 45.600C | (10 g) | (30 g) | | | | | | adhesive |
| Nolax | Vestimid | Polyolyfin | 17-06-6790 | AR | 154 | 41 | 78 | Delamination - |
| 45.600C | (10 g) | (30 g) | | | | | | adhesive |
| Nolax | Vestimid | Polyolyfin | 17-06-6790 | AR | 154 | 43 | 94 | Delamination - |
| A23.2240 | (20 g) | (60 g) | | | | | | adhesive |
| Nolax | Vestimid | Polyolyfin | 17-06-6790 | AR | 149 | 41 | 98 | Delamination - |
| A23.2240 | (20 g) | (60 g) | | | | | | adhesive |
| 17-03-16-1 | Hytrel | Hytrel | 17-09-7269 | 70 C. | 171 | 54 | 96 | Delamination - |
| | 4069 | 4056 | | 95% RH | | | | adhesive |
| | | | | 408 h | | | | |
| 17-03-16-1 | Hytrel | Hytrel | 17-09-7269 | 70 C. | 171 | 55 | 102 | Delamination - |
| | 4069 | 4056 | | 95% RH | | | | adhesive |
| | | | | 408 h | | | | |
| 17-03-16-1 | Hytrel | Hytrel | 17-09-7270 | 105 C./408 h | 171 | 55 | 110 | Delamination - |
| | 4069 | 4056 | | | | | | adhesive |
| 17-03-16-1 | Hytrel | Hytrel | 17-09-7270 | 105 C./408 h | 177 | 56 | 114 | Delamination - |
| | 4069 | 4056 | | | | | | adhesive |

### Example 2

In this study, the peel force of laminate films according to the present invention was determined under different conditions. OPW inflatable air bags were formed with PET 470 dtex Halead yarn. The air bags were sized, plain woven, hand laminated, and scoured. A coextruded laminate film of Hytrel® 4056 (adhesive layer) and Hytrel® 4069 (bather layer) was provided on each air bag. Table 2 shows the laminate film peel force when the laminated air bag was tested under different conditions.

In one test, each laminated air bag was subjected to a t-peel test immediately after exposure to a 15 minute steam bath. Although a significant drop in peel force is typically observed in these conditions, the laminate film of the present invention maintained t-peel strength at a relatively high level (above 1 N/mm).

TABLE 2

| | | | Test 1 | Test 2 | Test 3 | Avg | Delta |
|---|---|---|---|---|---|---|---|
| Initial | Weight | g | 10.709 | 10.741 | 10.835 | 10.762 | |
| (After drying 30 min at 150° C.) | Peel Force | N/mm | 1.69 | 1.75 | 1.76 | 1.733 | |
| After steam | Weight | g | 11.554 | 11.389 | 11.917 | 11.620 | 7.98% |
| | Peel Force | N/mm | 1.39 | 1.56 | 1.53 | 1.493 | −13.85% |
| After 24 hr conditioning | Weight | g | 10.855 | 10.888 | 10.983 | 10.909 | 1.37% |
| | Peel Force | N/mm | 1.69 | 1.74 | 1.79 | 1.740 | 0.38% |

### Example 3

In this study, the peel force of a laminate film according to the present invention was determined under elevated temperatures. OPW inflatable air bags were formed with PET 470 dtex Halead yarn. The air bags were plain woven and hand laminated, i.e., left in loom state. A coextruded laminate film of Hytrel® 4056 (adhesive layer) and Hytrel® 4069 (barrier layer) was provided on the air bag.

The air bags were then peeled, heated in a chamber, and peeled again. In particular, each laminated air bag was subjected to a t-peel test immediately after exposure to a 15 minute steam bath. The laminate film of the present invention maintained t-peel strength at a relatively high level (above 1 N/mm). The results are summarized in Table 3 below:

TABLE 3

| | | | Initial | Peel after |
|---|---|---|---|---|
| | | | Peel | post heat |
| Condition | Side | Weave | (N/mm) | (N/mm) |
| Hot press (177 C. fabric temp) | WS | Fill | 2 | 1.9 |
| Hot press (177 C. fabric temp) | WS | Fill | 1.9 | 1.8 |
| Hot press (177 C. fabric temp) | WS | Fill | 1.9 | 1.8 |
| Hot press (177 C. fabric temp) | WS | Warp | 1.9 | 1.9 |
| Hot press (177 C. fabric temp) | MS | Warp | 1.9 | 1.9 |
| Hot press (177 C. fabric temp) | MS | Warp | 1.7 | 1.6 |
| Hot press (177 C. fabric temp) | MS | Warp | 1.6 | 1.7 |
| Hot press (177 C. fabric temp) | MS | Fill | 1.8 | 1.7 |
| Hot press (177 C. fabric temp) | MS | Fill | 1.9 | 1.7 |
| Hot press (177 C. fabric temp) | MS | Fill | 2 | 1.8 |

### Example 4

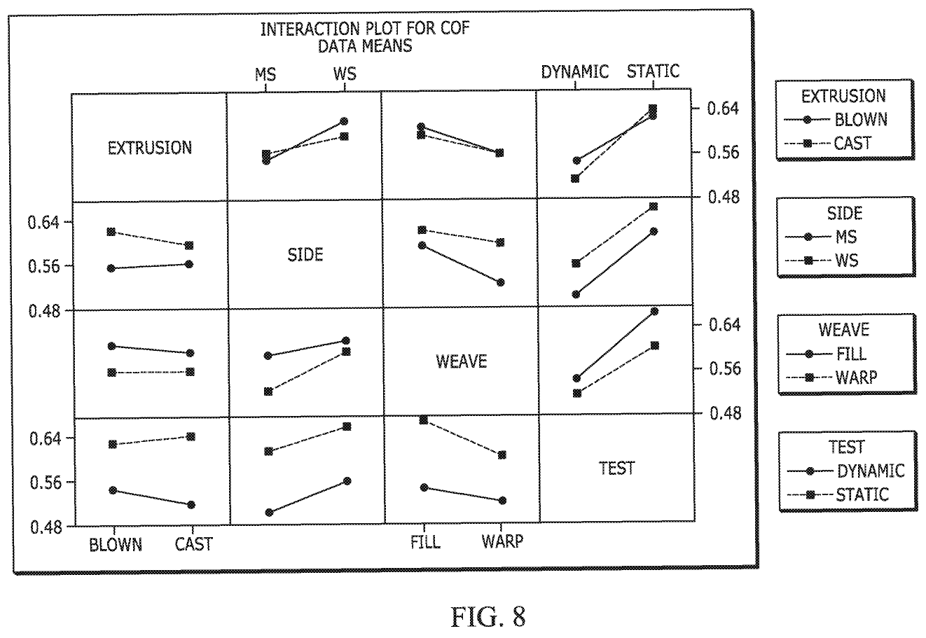

In this study, a layer of Arnitel® EM 550 was tested under various conditions and the coefficient of friction measured in each case. Referring to FIG. 8, the layer was tested when made by both blown extrusion and cast extrusion. The layer was also tested when positioned on both the marker side and white side of the OPW air bag. The layer was further tested with a fill weave and warp weave. Both static and dynamic testing was performed.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations.

Having described the invention, the following is claimed:

1. A laminate film for a vehicle occupant protection device, comprising:
at least one copolyester barrier layer; and
at least one copolyester adhesive layer connected to the at least one barrier layer.

2. The laminate film of claim 1, wherein the barrier layer comprises a thermoplastic polyester elastomer.

3. The laminate film of claim 1, wherein the adhesive layer comprises a thermoplastic polyester elastomer.

4. The laminate film of claim 1, wherein the melt temperature of the barrier layer is at least 200° C.

5. The laminate film of claim 1, wherein the melt temperature of the adhesive layer is about 150° C.

6. The apparatus of claim 1, wherein the melt temperature of the adhesive layer is at least 150′C.

7. The laminate film of claim 1, wherein the laminate film has a weight of about 45-60 g/m³.

8. The laminate film of claim 1, wherein the protection device forms an inflatable side curtain.

9. The laminate film of claim 1, wherein the laminate film has a t-peel adhesion strength of at least 1.0 N/mm.

10. The laminate film of claim 1, wherein the barrier layer and the adhesive layer are coextruded.

11. The laminate film of claim 1 further comprising a flame-retardant material.

12. The laminate film of claim 11, wherein the flame-retardant material is copolyester.

13. An apparatus for helping to protect an occupant of a vehicle, the apparatus comprising:
an inflatable vehicle occupant protection device comprising a plurality of panels defining an inflatable volume; and
the laminate film of claim 1 provided on the panels.

14. A method of forming an apparatus for helping to protect an occupant of a vehicle comprising:
weaving an inflatable vehicle occupant protection device comprising a plurality of panels defining an inflatable volume; and
laminating the panels with a film comprising at least one copolyester barrier layer and at least one copolyester adhesive layer connected to the at least one barrier layer.

15. The method of claim 14 further comprising coextruding the at least one adhesive layer with at least one barrier layer.

16. The method of claim 14, the step of laminating the panels comprising laminating loom state, woven fabric panels.
